(19) United States
(12) Patent Application Publication
(10) Pub. No.: US 2016/0328824 A1
(43) Pub. Date: Nov. 10, 2016

(54) METHOD AND SYSTEM FOR GENERATING MULTI-PROJECTION IMAGES

(71) Applicant: CJ CGV CO., LTD., Seoul (KR)

(72) Inventors: Hwan Chul KIM, Seoul (KR); Su Ryeon KANG, Goyang-si, Gyeonggi-do (KR); Jihyung KANG, Hwaseong-si, Gyeonggi-do (KR)

(21) Appl. No.: 14/897,582

(22) PCT Filed: Dec. 9, 2014
(86) PCT No.: PCT/KR2014/012083

§ 371 Date: Dec. 10, 2015

(30) Foreign Application Priority Data
Dec. 9, 2013 (KR) 10-2013-0152606
Dec. 3, 2014 (KR) 10-2104-0172173

(51) Int. Cl. G06T 3/00; H04N 13/00; H04N 5/04; H04N 5/232; H04N 9/31; H04N 5/372; H04N 13/02

(52) U.S. Cl. CPC G06T 3/0062; H04N 5/372; H04N 13/0007; H04N 13/0207; G06T 3/0093; H04N 5/23238; H04N 9/3147; H04N 5/04; H04N 2013/0074; G06T 2207/10021; G06T 2210/22

(57) ABSTRACT

Disclosed herein is a method of generating multi-projection images. The method of generating multi-projection images includes performing, by a wide view angle filming device capable of implementing an angle of view of 360°, a filming operation and specifying a main image region from among all the image regions filmed by the wide view angle filming device in a direction of 360°.

### TECHNICAL FIELD

The present invention relates to a method and system for generating multi-projection images and, more particularly, to a method and system capable of generating so-called “multi-projection images” using a wide view angle filming device capable of implementing an angle of view of 360°.

### BACKGROUND ART

In a prior art, in order to play back an image, such as a movie or an advertisement in a theater, a two-dimensional (2D) image is projected on a single screen disposed at the front of a movie theater. In such a system, audiences inevitably experience only the 2D image.

3D image-related technologies capable of providing stereoscopic images to audience have recently been developed. A 3D image technology is based on a principle that when different images enter the left eye and right eye of a person and are merged in the brain, the person perceives the merged images as a 3D image. In such a 3D image technology, two cameras on which different polarization filters are mounted are used to capture images. When watching an image, a person wears glasses on which polarization filters are mounted so that different images enter the left eye and right eye of the person.

However, such a 3D technology may provide a stereoscopic image to a user, but is problematic in that a degree of immersion for an image itself played back in a single screen is low because the user merely watches the image. Furthermore, there is a problem in that the direction of a 3D effect felt by audiences is limited to the direction in which a single screen is disposed.

Furthermore, a conventional 3D technology is problematic in that it may cause inconvenience for audiences who watch images because the audiences must wear glasses on which polarization filters are mounted and that a sensitive user may feel dizzy or sick because different images are forced to enter the left eye and right eye of the user.

Accordingly, a so-called “multi-projection system” capable of solving the problems of the conventional screening system based on a single screen was proposed. In this case, the “multi-projection system” means a technology for disposing a plurality of projection planes (or a plurality of display devices) around the seats for the audience and playing back synchronized images having a sense of unity on the plurality of projection planes (or the plurality of display devices) so that audiences may have a 3D effect and a sense of immersion.

In order to maximize a sense of immersion and a 3D effect felt by audiences using such as a “multi-projection system”, images matched with the viewpoint directions of respective projection planes (or respective display devices) need to be played back on a plurality of the projection planes (or a plurality of the display devices) disposed around the seats for the audience.

For example, assuming that there is a movie theater in which a plurality of projection planes (or a plurality of display devices) is disposed at the front and on the left and right sides of the seats for the audience as illustrated in FIG. 1, an image matched with a viewpoint that views the front on the basis of the seats for the audience needs to be played back the projection plane (or the display device) at the front, an image matched with a viewpoint that views the left on the basis of the seats for the audience needs to be played back in the projection plane (or the display device) on the left side, and an image matched with a viewpoint that views the right on the basis of the seats for the audience needs to be played back in the projection plane (or the display device) on the right side.

In a prior art, however, there is no technology for generating so-called “multi-projection images” that will be played back in a plurality of projection planes (or a plurality of display devices) of such a “multi-projection system”.

Accordingly, there is a need for the development of a new technology capable of solving such a technical need.

The present invention has been invented based on such a technical background and has been invented to satisfy the aforementioned technical need and also to provide additional technical elements that may not be easily invented by those skilled in the art.

### SUMMARY OF INVENTION

### Technical Problem

Accordingly, the present invention has been made in view of the above problems, and it is an object of the present invention to provide a technology for generating so-called “multi-projection images” to be played back in a plurality of projection planes (or a plurality of display devices) disposed in a plurality of viewpoint directions around the seats for the audience. In particular, an object of the present invention is to provide a technology for generating “multi-projection images” using a wide view angle filming device capable of implementing an angle of view of 360°.

Technical objects to be achieved by the present invention are not limited to the aforementioned object, and they may include various technical objects that are evident to those skilled in the art from the following description.

### Solution to Problem

In accordance with an aspect of the present invention, a method of generating multi-projection images includes performing, by a wide view angle filming device capable of implementing an angle of view of 360°, a filming operation and specifying a main image region from among all image regions filmed by the wide view angle filming device in a direction of 360.

Furthermore, in the method of generating multi-projection images, the wide view angle filming device may have a controllable height and perform the filming operation in a specific height or more.

Furthermore, in the method of generating multi-projection images, all the images captured by the wide view angle filming device in a direction of 360° may be displayed in such a way as to be spread on a two-dimension (2D) plane or may be displayed in such a way as to be matched with respective filming direction angles.

In this case, all the images captured by the wide view angle filming device may be displayed on the 2D plane by image warping.

The method of generating multi-projection images further includes cropping the main image region and image regions within a specific range of an angle of view based on the main image region.

Furthermore, the method of generating multi-projection images may further include mapping the cropped image regions to a spherical space or cylindrical space and generating images of respective planes.

In accordance with another aspect of the present invention, a system for generating multi-projection images includes a wide view angle filming device configured to implement an angle of view of 360° and perform a filming operation in a direction of 360° and an image processing device configured to specify a main image region from among all the image regions filmed by the wide view angle filming device in a direction of 360° and generate images to be played back in the respective planes of a movie theater based on the specified main image region.

Furthermore, in the system for generating multi-projection images, the wide view angle filming device may include a camera module configured to perform the filming operation and a reflection module configured to transfer light incident in a direction of 360° to the camera module.

Furthermore, in the system for generating multi-projection images, the image processing device may be configured to display all the images captured by the wide view angle filming device in a direction of 360° in such a way as to spread all the images on a two-dimension (2D) plane or to display all the images in such a way as to match all the images with respective filming direction angles.

Furthermore, in the system for generating multi-projection images, the image processing device may be configured to crop the main image region and image regions within a specific range of an angle of view based on the main image region.

In this case, the image processing device may map the cropped image regions to a spherical space or cylindrical space and generate images of the respective planes.

### Advantageous Effects of Invention

The present invention can generate so-called “multi-projection images” that are played back on the plurality of projection planes (or the plurality of display devices) of the “multi-projection system” and that are capable of improving a 3D effect and a sense of immersion felt by audiences. More specifically, the present invention can obtain images in a plurality of viewpoint directions using the wide view angle filming device capable of implementing an angle of view of 360° and generate so-called “multi-projection images” based on the obtained images.

Furthermore, the present invention can generate multi-projection images using only a single filming device. More specifically, the present invention can generate multi-projection images without a lot of time that is taken to dispose a plurality of filming devices in a plurality of viewpoint directions, controlling the shutter operations of a plurality of filming device so that they are synchronized, or process (e.g., stitching or color space integration) image data filmed by a plurality of filming device as in a prior art.

Furthermore, the present invention can generate multi-projection images optimized for the structure of each movie theater in which the multi-projection system has been constructed. More specifically, the present invention can generate multi-projection images optimized for the structure of each movie theater by obtaining source images using the wide view angle filming device capable of implementing an angle of view of 360°, mapping the obtained source images to a spherical space or cylindrical space, and then generating multi-projection images for the movie theater.

Technical effects of the present invention are not limited to the aforementioned effects, and they may include various effects that are evident to those skilled in the art from the following description.

### BRIEF DESCRIPTION OF DRAWINGS

FIG. 1 is an exemplary diagram illustrating an example of a multi-projection system;

FIG. 2 is a flowchart illustrating a method of generating multi-projection images in accordance with an embodiment of the present invention;

FIG. 3 is an exemplary diagram illustrating an example of a wide view angle filming device in accordance with an embodiment of the present invention;

FIG. 4 is an exemplary diagram illustrating images captured by the wide view angle filming device in accordance with an embodiment of the present invention;

FIG. 5 is an exemplary diagram illustrating an example in which an image captured by the wide view angle filming device in accordance with an embodiment of the present invention is converted into a form of an image spread on a 2D plane;

FIG. 6 is an exemplary diagram illustrating that source images generated based on an image captured by the wide view angle filming device in accordance with an embodiment of the present invention have been mapped to a spherical space;

FIG. 7 is an exemplary diagram illustrating that source images generated based on an image captured by the wide view angle filming device in accordance with an embodiment of the present invention have been mapped to a cylindrical space; and

FIG. 8 is a diagram illustrating the configuration of elements that may be included in a system for generating multi-projection images in accordance with an embodiment of the present invention.

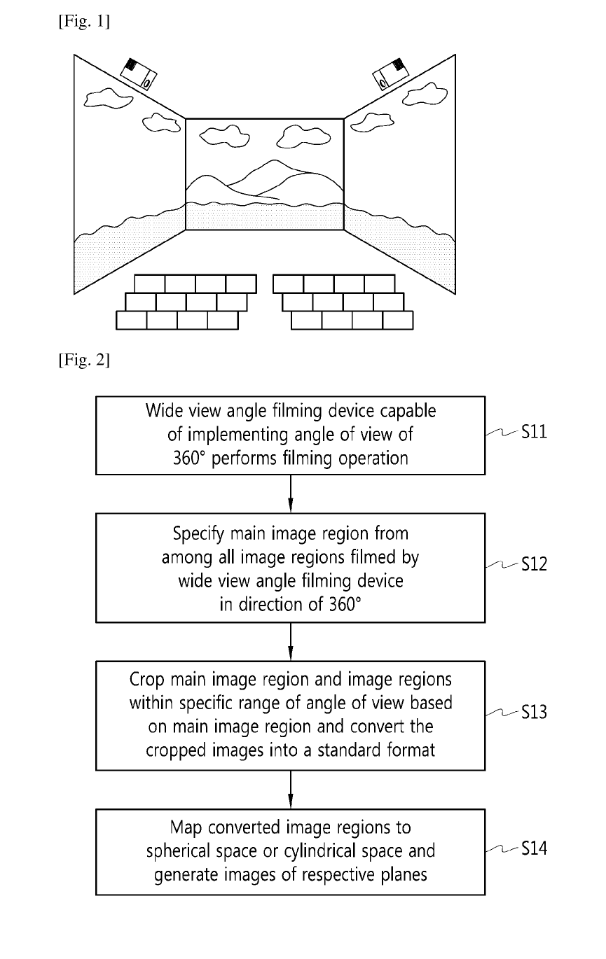

<Description of reference numerals>

| | |
|---|---|
| 100 wide view angle filming device | |
| 110 camera module | |
| 120 reflection module | 200 image processing device |

### MODE FOR THE INVENTION

Hereinafter, a method and system for generating multi-projection images” in accordance with embodiments of the present invention are described in detail with reference to the accompanying drawings. The embodiments to be described are provided in order for those skilled in the art to easily understand the technical spirit of the present invention, and the present invention is not limited to the embodiments. Furthermore, matters represented in the accompanying drawings have been diagrammed in order to easily describe the embodiments of the present invention, and the contents may be different from forms that are actually implemented.

Each of the elements represented herein is only an example for implementing the embodiments of the present invention. Accordingly, in other implementations of the present invention, different elements may be used without departing from the spirit and scope of the present invention. Furthermore, each element may be purely formed of a hardware or software element, but may also be implemented using a combination of various hardware and software elements that perform the same function.

Furthermore, an expression that some elements are “included” is an expression of an “open type”, and the expression simply denotes that the corresponding elements are present, but it should not be understood that additional elements are excluded.

Furthermore, an expression of a “multi-projection image” means an image that is played back through a plurality of projection planes (or a plurality of display devices) disposed around the seats for the audience and that is capable of improving a sense of immersion and 3D effect felt by audiences.

A method of generating multi-projection images in accordance with an embodiment of the present invention is described below with reference to FIGS. 2 to 7.

Referring to FIG. 2, the method of generating multi-projection images in accordance with an embodiment of the present invention may include performing, by a wide view angle filming device 100 capable of implementing an angle of view of 360°, a filming operation at step S11, specifying a main image region from among all the image regions filmed by the wide view angle filming device 100 in a direction of 360° at step S12, cropping the main image region and image regions within a specific range of an angle of view on the basis of the main image region at step S13, and mapping the cropped image regions to a spherical space or cylindrical space and generating images of respective planes at step S14.

The wide view angle filming device 100 may perform a filming operation in response to an external control command. In this case, the subject that generates the control command may be hardware having an operation processing ability. Such hardware may be independently present in a separate device form, for example, as a filming control device. Alternatively, an image processing device 200 may generate the control command.

At step S11, the wide view angle filming device 100 capable of implementing an angle of view of 360° performs a filming operation. More specifically, at step S11, the wide view angle filming device 100 capable of implementing an angle of view of 360° obtains images in a direction of 360° at the same time.

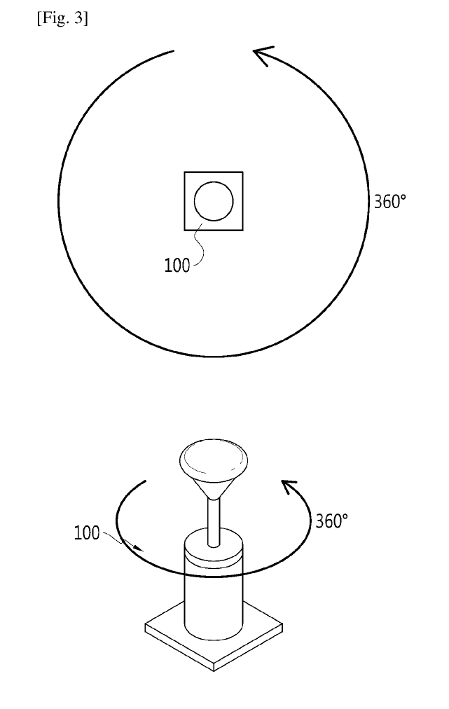

The wide view angle filming device 100 used at step S11 may be configured to implement an angle of view of 360° in a horizontal direction as illustrated in FIG. 3. More specifically, the wide view angle filming device 100 may be configured to receive light incident in all the horizontal directions (i.e., a direction of 360°) and transfer the light to an image sensor.

To this end, the wide view angle filming device 100 may include a camera module configured to perform a filming operation and a reflection module configured to transfer light in a direction of 360° to the camera module. In this case, the camera module includes an image sensor, such as a Charge Coupled Device (CCD), a lens, and a Digital Signal Processor (DSP) and performs a filming operation using light received from the reflection module. Furthermore, the reflection module transfers light incident in a direction of 360° to the camera module. The reflection module may be implemented in a conical form and may be made of materials capable of reflecting light.

A technical problem in a filming site may include a problem in that a shape of a person who manages and controls an apparatus enters the angle of view if filming is performed a wide angle of view of 360° as described above.

In order to solve such a problem, the wide view angle filming device 100, in particular, the camera module may be placed in a specific height or more (e.g., 2 m). In particular, the above problem may be solved by performing filming in a place higher than the height of a filming person, for example, over the head of the filming person.

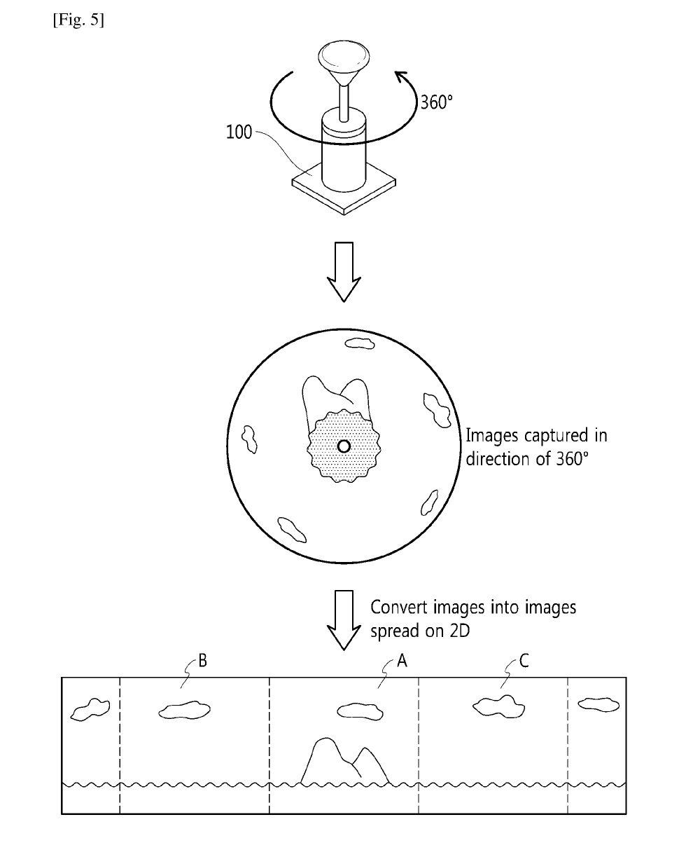

Furthermore, at step S11, all the images captured by the wide view angle filming device 100 in a direction of 360° may be displayed in various forms. For example, all the images may be displayed using various methods, including 1) a display method of an angle type in which each image is matched with a direction angle at which the image is captured and displayed and 2) a display method of a 2D plane type in which all the images captured in a direction of 360° are spread on a 2D plane. Referring to FIG. 5, all the images captured by the wide view angle filming device 100 in a direction of 360° are displayed using the display method of an angle type and then displayed using the display method of a 2D plane type.

When images captured by the wide view angle filming device 100 are to be displayed on a 2D plane, the distortion of an image may be inevitably generated. Such a distortion of an image may be overcome by an image warping technology, that is, a technology for correcting the original image by matching the locations of the pixels of the original image with locations on a 2D plane, that is, a new projection plane. In particular, if the image warping technology is used, the bending modulus of an image can be controlled. A problem in that an image captured by the wide view angle filming device 100 is distorted can be solved by storing the designated bending modulus of the captured image as a fixed value.

At step S12, a main image region is specified in all the image regions filmed by the wide view angle filming device 100 in a direction of 360°. More specifically, at step S12, assuming that a movie is made, an image region including a main scene is specified in all the image regions in a direction of 360°.

Such a specification of the main image region may be performed using various methods. For example, the main image region may be specified based on data input by a user or may be automatically specified by the image processing of an operation device. For another example, the specification of the main image region may be performed by specifying images captured in a specific direction as the main image region after a specific direction (i.e., a direction toward which a specific body part of the wide view angle filming device 100 is directed or an absolute specific horizontal direction) is previously set. In addition, the main image region may be specified in various ways.

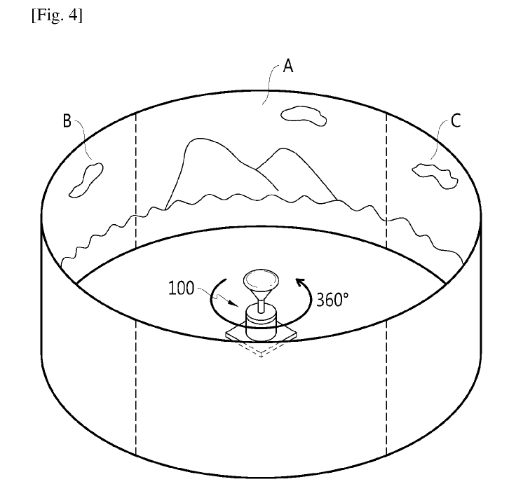

FIG. 4 or 5 illustrates an example in which a main image region A has been specified in image regions filmed by the wide view angle filming device 100 in a direction of 360°.

At step S13, source images (i.e., images that belong to the images captured in a direction of 360° and that are actually used to generate multi-projection images) are generated based on the images captured by the wide view angle filming device 100 in a direction of 360°. More specifically, at step S13, the source images are generated by cropping the main image region and image regions within a specific range of an angle of view on the basis of the main image region.

In such a case, the angles of view of the main image region and the image regions included in the source images may be set in various ranges. For example, 1) an image region within a range of an angle of view of 60° on the left side and right side of the main image region, 2) an image region within a range of an angle of view of 90° on the left side and right side of the main image region, and 3) an image region within all the ranges of an angle of view other than the main image region (In such a case, source images become images themselves in a direction of 360°) may be set in various ways. However, in either case, the source images may be formed to include image regions having a range of an angle of view of 270° or more. The reason for this is that multi-projection images capable of maximizing a sense of immersion and 3D effect felt by audiences can be generated only when the multi-projection images are generated based on image regions having a range of an angle of view of 270° or more.

Referring to FIG. 4 or 5, the main image region A and image regions B and C within a specific range of an angle of view based on the main image region have been specified in all the image regions filmed by the wide view angle filming device 100. The image regions A, B, and C may be together cropped and included in the source images.

At step S14, multi-projection images are generated based on the source images. More specifically, at step S14, images to be played back in the respective planes (e.g., respective projection planes or planes in which respective display devices have been installed) of a movie theater in which a multi-projection system has been constructed are generated based on the source images.

In such a case, the source images may be together mapped to a spherical space or cylindrical space. After such mapping is performed, images corresponding to the respective planes (e.g., respective projection planes or planes in which respective display devices have been installed) of a movie theater may be generated.

In order to generate multi-projection images capable of maximizing a sense of immersion and 3D effect felt by audiences, images of respective planes need to be generated by taking into consideration the structure of a movie theater. The reason for this is that in the state in which the source images have been mapped to a spherical space or cylindrical space, image regions corresponding to the arrangement states of respective planes (e.g., respective projection planes or planes in which respective display devices have been installed) on a 3D can be easily specified and allocated.

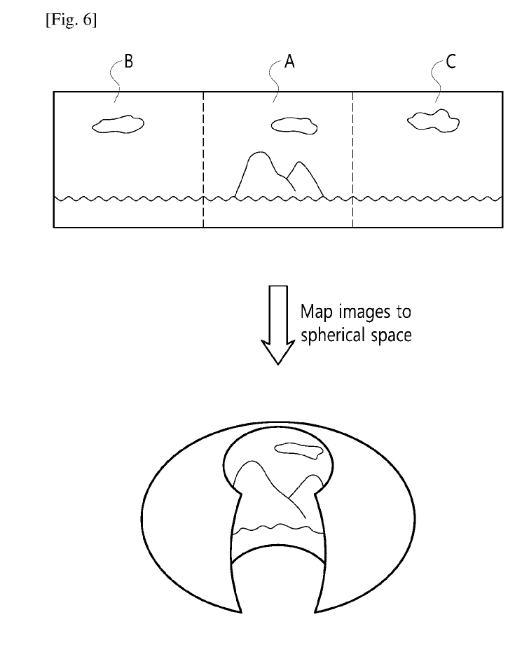

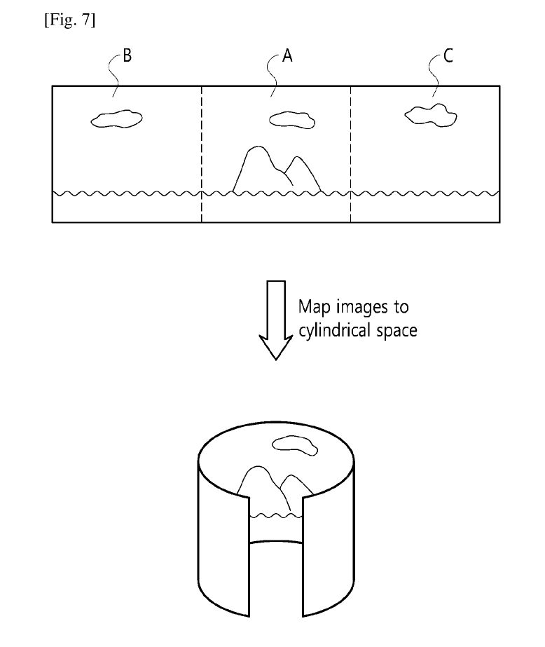

FIG. 6 illustrates an example in which the source images have been together mapped to a spherical space. Furthermore, FIG. 7 illustrates an example in which the source images have been together mapped to a cylindrical space.

In the method of generating multi-projection images described above in accordance with an embodiment of the present invention, multi-projection images to be played back in the respective projection planes (or respective display devices) of a movie theater in which the multi-projection system has been constructed may be generated based on images captured by the wide view angle filming device 100 in a direction of 360°. More specifically, the method of generating multi-projection images may include generating source images including a main image region based on images captured by the wide view angle filming device 100 in a direction of 360°, mapping the source images to a specific space together, specifying image regions corresponding to the arrangement states of respective projection planes (or respective display devices), and generating so-called multi-projection images.

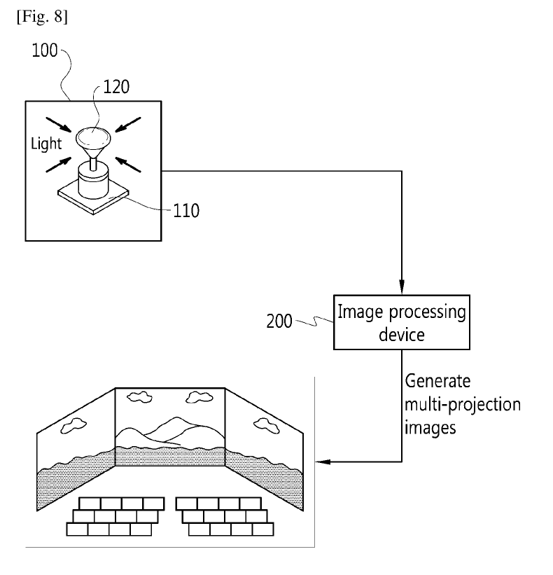

A system for generating multi-projection images in accordance with an embodiment of the present invention is described below with reference to FIG. 8.

Referring to FIG. 8, the system for generating multi-projection images in accordance with an embodiment of the present invention may include the wide view angle filming device 100 configured to implement an angle of view of 360° and perform a filming operation in a direction of 360° and the image processing device 200 configured to specify a main image region from among all the image regions filmed by the wide view angle filming device in a direction of 360° and generate images to be played back in the respective planes of a movie theater based on the specified main image region.

The wide view angle filming device 100 is configured to implement an angle of view of 360° and perform a filming operation in a direction of 360°. The wide view angle filming device 100 may be configured to implement an angle of view of 360° in a horizontal direction. More specifically, the wide view angle filming device 100 may be configured to receive light incident in all the horizontal directions (i.e., a direction of) 360° and transfer the light to an image sensor.

The wide view angle filming device 100 may include a camera module 110 configured to perform a filming operation and a reflection module 120 configured to transfer light incident in a direction of 360° to the camera module 110. A filming operation in a direction of 360° may be performed using the camera module 110 and the reflection module 120. The camera module 110 includes an image sensor, such as a Charge Coupled Device (CCD), a lens, and a Digital Signal Processor (DSP) and performs a filming operation using light received from the reflection module 120. Furthermore, the reflection module 120 is configured to transfer light incident in a direction of 360° to the camera module 110. The reflection module 120 may be implemented in a conical shape and may be made of materials capable of reflecting light.

The image processing device 200 is configured to receive images captured by the wide view angle filming device 100 and generate multi-projection images by performing an image processing operation on the received images.

The image processing device 200 may display all the images captured by the wide view angle filming device 100 in a direction of 360° so that the images are spread on a 2D plane (i.e., through image processing for a display of an angle type) or so that the images are matched with filmed direction angles (i.e., through image processing for a display of a 2D plane type).

Furthermore, the image processing device 200 may specify a main image region (i.e., an image region that belongs to all the image regions in a direction of 360° and that includes a main scene) from among all the image regions filmed by the wide view angle filming device 100 in a direction of 360°. In such a case, the image processing device 200 may specify the main image region while operating in conjunction with an input device for receiving data from a user or may specify the main image region by performing its own operation based on a predetermined algorithm. Furthermore, the image processing device 200 may specify an image region, filmed in a predetermined specific direction (i.e., a direction toward which a specific body part is directed based on the body of the wide view angle filming device 100 or an absolute specific horizontal direction), as the main image region.

Furthermore, at step S13, the image processing device 200 may generate source images (i.e., images that belong to images captured by the wide view angle filming device 100 in a direction of 360° and that are actually used to generate multi-projection images) based on the images captured by the wide view angle filming device 100 in a direction of 360°. More specifically, the image processing device 200 may generate the source images by cropping a main image region and image regions within a specific range of an angle of view based on the main image region from among all the image regions filmed by the wide view angle filming device 100.

Furthermore, the image processing device 200 may generate the multi-projection images based on the source images. More specifically, the image processing device 200 may generate images to be played back in the respective planes (e.g., respective projection planes or planes in which respective display devices have been installed) of a movie theater in which the multi-projection system has been constructed by performing an image processing process based on the source images. In such a case, the image processing device 200 may map the source images to a spherical space or cylindrical space together. After such mapping is performed, the image processing device 200 may generate the images corresponding to the respective planes (e.g., respective projection planes or planes in which respective display devices have been installed) of a movie theater.

The image processing device 200 may include at least one operation means and at least one storage means. In this case, the operation means may be a general-purpose CPU, but may be a programmable device (e.g., a CPLD or an FPGA), an ASIC, or a microcontroller chip implemented for a specific purpose. Furthermore, the storage means may be a volatile memory device, a non-volatile memory, a non-volatile electromagnetic storage device, or memory within the operation means.

As described above, the system for generating multi-projection images in accordance with an embodiment of the present invention may include substantially the same technical characteristics as the method of generating multi-projection images in accordance with an embodiment of the present invention although they belong to different categories.

Accordingly, although not described in detail in order to avoid redundancy, the characteristics described in relation to the method of generating multi-projection images may also be deduced and applied to the system for generating multi-projection images in accordance with an embodiment of the present invention. Furthermore, on the contrary, the characteristics described in relation to the system for generating multi-projection images may also be deduced and applied to the method of generating multi-projection images.

The aforementioned embodiments of the present invention have been disclosed for illustrative purposes, but the present invention is not restricted by the embodiments. Furthermore, those skilled in the art to which the present invention pertains may modify and change the present invention in various ways within the spirit and scope of the present invention, and such modifications and changes should be construed as falling within the scope of the present invention.

1. A method of generating multi-projection images, comprising:
performing, by a wide view angle filming device capable of implementing an angle of view of 360°, a filming operation; and
specifying a main image region from among all image regions filmed by the wide view angle filming device in a direction of 360°.

2. The method of claim 1, wherein the wide view angle filming device has a controllable height and performs the filming operation in a specific height or more.

3. The method of claim 1, wherein all the images captured by the wide view angle filming device in a direction of 360° are displayed in such a way as to be spread on a two-dimension (2D) plane or displayed in such a way as to be matched with respective filming direction angles.

4. The method of claim 3, wherein all the images captured by the wide view angle filming device are displayed on the 2D plane by image warping.

5. The method of claim 1, further comprising cropping the main image region and image regions within a specific range of an angle of view based on the main image region.

6. The method of claim 5, further comprising mapping the cropped image regions to a spherical space or cylindrical space and generating images of respective planes.

7. A system for generating multi-projection images, comprising:
a wide view angle filming device configured to implement an angle of view of 360° and perform a filming operation in a direction of 360°; and
an image processing device configured to specify a main image region from among all image regions filmed by the wide view angle filming device in a direction of 360° and generate images to be played back in respective planes of a movie theater based on the specified main image region.

8. The system of claim 7, wherein the wide view angle filming device comprises:
a camera module configured to perform the filming operation; and
a reflection module configured to transfer light incident in a direction of 360° to the camera module.

9. The system of claim 7, wherein the image processing device displays all the images captured by the wide view angle filming device in a direction of 360° in such a way as to spread all the images on a two-dimension (2D) plane or displays all the images in such a way as to match all the images with respective filming direction angles.

10. The system of claim 7, wherein the image processing device crops the main image region and image regions within a specific range of an angle of view based on the main image region.

11. The system of claim 10, wherein the image processing device maps the cropped image regions to a spherical space or cylindrical space and generates images of respective planes.
